(19) United States
(12) Patent Application Publication
(10) Pub. No.: US 2012/0147155 A1
(43) Pub. Date: Jun. 14, 2012

(54) APPARATUS FOR DISPLAYING STEREOSCOPIC IMAGE

(76) Inventor: Masako KASHIWAGI, Kanagawa-ken (JP)

(21) Appl. No.: 13/233,263

(22) Filed: Sep. 15, 2011

(30) Foreign Application Priority Data
Dec. 10, 2010 (JP) P2010-276115

(51) Int. Cl. H04N 13/04

(52) U.S. Cl. 348/51; 348/E13.075

(57) ABSTRACT

According to one embodiment, an apparatus for displaying a stereoscopic image includes an illuminator, a display unit, and an image control element. The illuminator includes a plurality of illumination units. Each illumination unit is configured to emit a plurality of luminous fluxes. Each luminous flux is emitted along one direction differently. The display unit is oppositely located to the illuminator, on which a plurality of sub pixels is arranged. Each sub pixel is configured to display a parallax image corresponding to the luminous flux in one direction. The image control element is oppositely located to the illuminator via the display unit, on which a plurality of apertures is arranged. Each aperture is configured to control a direction of the parallax image.

### CROSS-REFERENCE TO RELATED APPLICATION

This application is based upon and claims the benefit of priority from Japanese Patent Application No. 2010-276115, filed on Dec. 10, 2010; the entire contents of which are incorporated herein by reference.

### FIELD

Embodiments described herein relate generally to an apparatus for displaying a stereoscopic image.

### BACKGROUND

Recently, a stereoscopic image display apparatus is widely used. In this apparatus, at a position opposed to a display panel, an optical control element to control a direction of a light ray from the display panel is arranged. By presenting a plurality of parallax images (each differently having a parallax) to respective eye (right eye, left eye) of observers, each observer can perceive a stereoscopic image with both eyes.

However, as to this apparatus, one able to display a parallax image having the larger number of parallaxes is desired.

### BRIEF DESCRIPTION OF THE DRAWINGS

FIGS. 1A and 1B are schematic diagrams showing a component of a stereoscopic image display apparatus according to a first embodiment.

FIG. 2 is a schematic diagram showing a relationship among each component in FIGS. 1A and 1B.

FIGS. 3A and 3B are schematic diagrams of a display unit 13 and an image control element 14 in FIGS. 1A and 1B.

FIGS. 4A and 4B are schematic diagrams showing an emission direction of a luminous flux in case of “N (time division number)=2 and m (parallax number of one field)=6”.

FIGS. 5A, 5B and 5C are schematic diagrams showing an emission direction of a luminous flux in case of “N (time division number)=3 and m (parallax number of one field)=6”.

FIG. 6 is a schematic diagram showing location of a light source S in an emitter 111 in FIGS. 1A and 1B.

FIGS. 7A and 7B are graphs showing luminance-distribution of the luminous flux from the emitter 111.

FIGS. 8A and 8B are graphs showing a relationship between a luminance and an angle of the luminous flux for each filed.

FIGS. 9A and 9B are graphs showing change of the luminance by correction.

FIGS. 10A and 10B are graphs showing change of luminance-distribution of all parallax by correction.

FIG. 11 is a graph showing a relationship between a gradation and a normalized luminance.

FIG. 12 is a schematic diagram of the emitter 111 and a luminous flux control element 112 according to a second embodiment.

FIG. 13 is a schematic diagram of the emitter 111 and the luminous flux control element 112 according to a third embodiment.

FIG. 14 is a schematic diagram of the emitter 111 according to a fourth embodiment.

FIG. 15 is a schematic diagram of the emitter 111 according to a modification of the fourth embodiment.

### DETAILED DESCRIPTION

According to one embodiment, an apparatus for displaying a stereoscopic image includes an illuminator, a display unit, and an image control element. The illuminator includes a plurality of illumination units. Each illumination unit is configured to emit a plurality of luminous fluxes. Each luminous flux is emitted along one direction differently. The display unit is oppositely located to the illuminator, on which a plurality of sub pixels is arranged. Each sub pixel is configured to display a parallax image corresponding to the luminous flux in one direction. The image control element is oppositely located to the illuminator via the display unit, on which a plurality of apertures is arranged. Each aperture is configured to control a direction of the parallax image.

Various embodiments will be described hereinafter with reference to the accompanying drawings.

### The First Embodiment

A stereoscopic image display apparatus 1 (Hereinafter, it is called “the apparatus 1”) according to the first embodiment is suitable for 3D-television by which an observer can observe a stereoscopic image with eyes.

The apparatus 1 generates a plurality of luminous fluxes each differently having a directivity of N directions by time division (time division number is N). Furthermore, the apparatus 1 emits a parallax image of one field corresponding to each luminous flux along m-parallax directions (parallax number of each field is m). As a result, the apparatus 1 generates a stereoscopic image having a parallax number (N×m) for one frame (N fields).

Moreover, as to a parallax image of one field, one unit of parallax numbers 1˜m corresponding to each parallax is called an elemental image.

In the apparatus 1, location of each light source of an emitter 111 (explained afterwards) is designed based on a lens pitch of a luminous flux control element 112 (explained afterwards). As a result, occurrence of crosstalk can be suppressed.

Furthermore, in the apparatus 1, image data of the parallax image (inputted) is corrected based on a correction table (explained afterwards). As a result, occurrence of luminance irregularity can be suppressed.

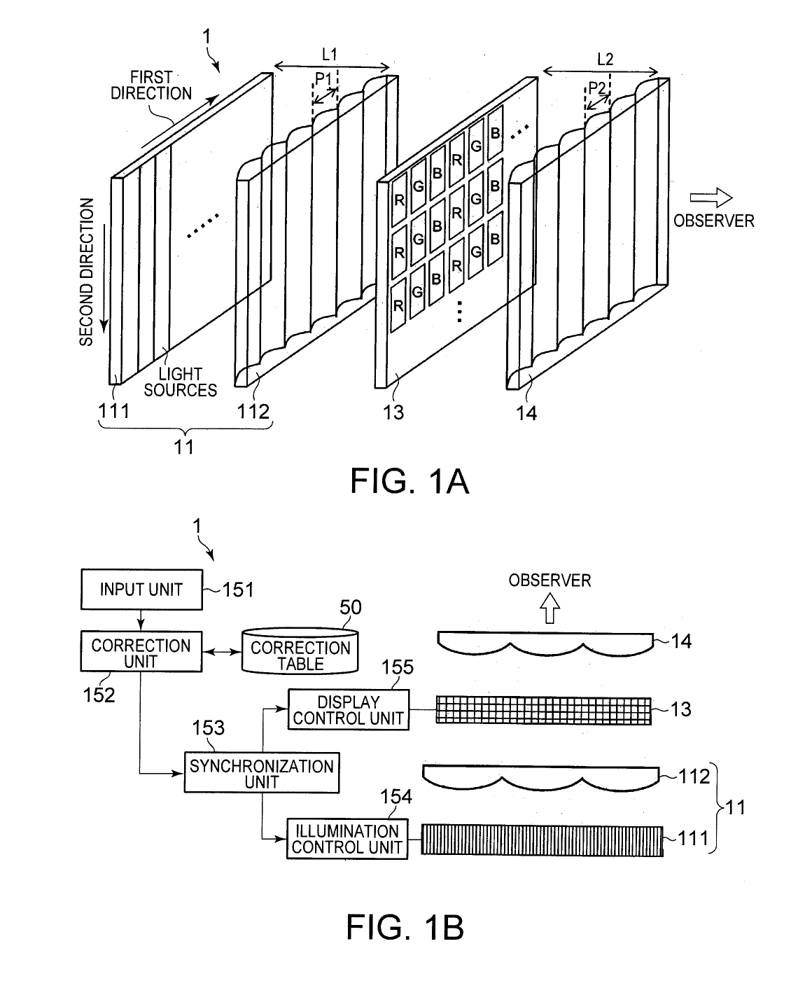

FIGS. 1A and 1B are schematic diagrams showing component of the apparatus 1. FIG. 1A shows a hardware component thereof. FIG. 1B shows a hardware component and a functional block thereof. The hardware component of FIG. 1B is a view of the hardware component of FIG. 1A from the upper direction.

The apparatus 1 includes an illuminator 11, a display unit 13, an image control element 14, a correction table 50, an input unit 151, a correction unit 152, a synchronization unit 153, an illumination control unit 152, and a display control unit 155. The illuminator 11 includes an emitter 111 and a luminous flux control element 112. In the illuminator 11, one lens is regarded as one optical element unit. A component including a plurality of light sources S corresponding to the optical element unit, and the optical element unit, are an illumination unit.

For example, the illuminator 11 may be a directional backlight disclosed in JP-A 2009-53345 (Kokai).

The emitter 11 includes a plurality of light sources S. Each light source S can be independently switched on and off. As to the first embodiment, light sources S of N sets are switched on and off by time division. A light source Sₙ (n=1˜N) of one set generates a luminous flux corresponding to a parallax image of one field.

Briefly, light sources s₁˜s_{N} of all sets generate luminous fluxes of a parallax image of N fields. In the first embodiment, each field is described with different sign.

The luminous flux control element 112 controls a direction of a luminous flux emitted from each light source S of the emitter 111. Concretely, the luminous flux control element 112 controls an advance direction of each luminous flux to go the luminous flux (emitted from the light source S of one set) along the same direction. Briefly, light sources S of N sets generate luminous fluxes along N directions.

The display unit 13 displays a parallax image for the luminous flux passed through the luminous flux control element 112. For example, the display unit 13 is a liquid crystal panel (liquid crystal shutter and a color filter).

The image control element 14 controls a direction of the luminous flux (parallax image) passed through the display unit 13. In the first embodiment, by combination of the display unit 13 and the image control element 14, a parallax image having m parallaxes for one field is displayed.

Briefly, when an observer observes the display unit 13 via the image control element 14 from some view position, because of occurrence of binocular parallax by the image control element 14, the observer can selectively view an image of a parallax number corresponding to the view position with the right eye and left eye. As a result, the observer can perceive a stereoscopic image.

In the first embodiment, the case that the luminous flux control element 112 and the image control element 14 are a lenticular sheet (cylindrical lens array) is explained. However, they may be a parallax barrier.

The input unit 151 inputs image data (including luminance values) of a parallax image. The correction table 50 stores correction information to correct the image data. The correction information is used for fixing a luminance irrespective of the observer's viewing angle for the apparatus 1.

By referring to the correction table 50, the correction unit 152 corrects the image data inputted. The image data corrected is supplied to the illumination control unit 154 and the display control unit 155 via the synchronization unit 153.

The illumination control unit 154 controls the emitter 111 based on the image data supplied, and makes each light source switch on and off.

The display control unit 155 controls the display unit 13 based on the image data supplied, and makes the display unit 13 display the parallax image.

As shown in FIG. 1A, the luminous flux control element 112 is located at a position opposed to the emitter 111. The display unit 13 is located at a position opposed to the luminous flux control element 112 and the opposite side of the emitter 111. The image control element 14 is located at a position opposed to the display unit 13 and the opposite side of the luminous flux control element 112.

Moreover, in the first embodiment, the emitter 111, the luminous flux control element 112, the display unit 13 and the image control element 14, had better be located in parallel with each other. However, this location relationship may include an error for design.

Hereinafter, the apparatus of the first embodiment is explained in detail. In the first embodiment, by combining a time division method and a space sharing method, a parallax number of the stereoscopic image becomes larger.

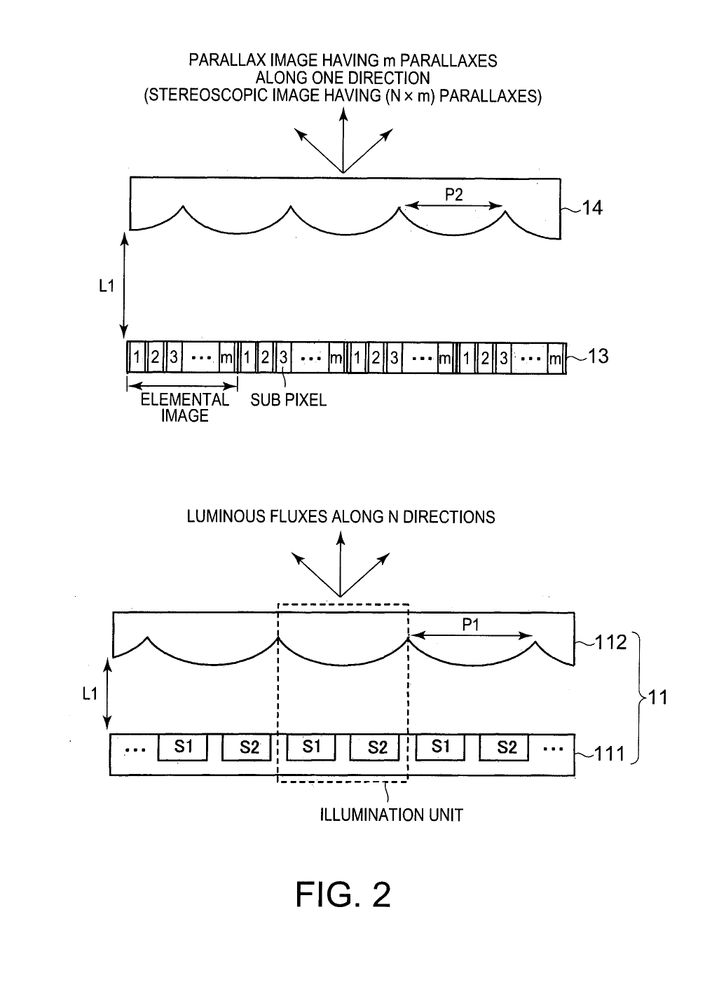

FIG. 2 shows a positional relationship among the emitter 111, the luminous flux control element 112, the display unit 13 and the image control element 14. FIG. 2 is a view of each hardware component of FIG. 1A from the upper direction. In FIG. 2, the case of the time division number “N=2” is shown.

If the time division number is N, the number of light sources S of the emitter 111 (corresponding to one lens of the luminous flux control element 112) is N. In FIG. 2, as to one lens of the luminous flux control element 112, two light sources S1 and S2 are corresponded.

By simultaneously lighting (switching on) the light sources S (For example, S1) having the same sign, the emitter 111 generates luminous fluxes of one field. Then, by switching light sources S (For example, S1, S2) having different signs of N sets on and off in time division, the emitter 111 generates luminous fluxes of N fields. Moreover, each light source S may change a luminous respectively.

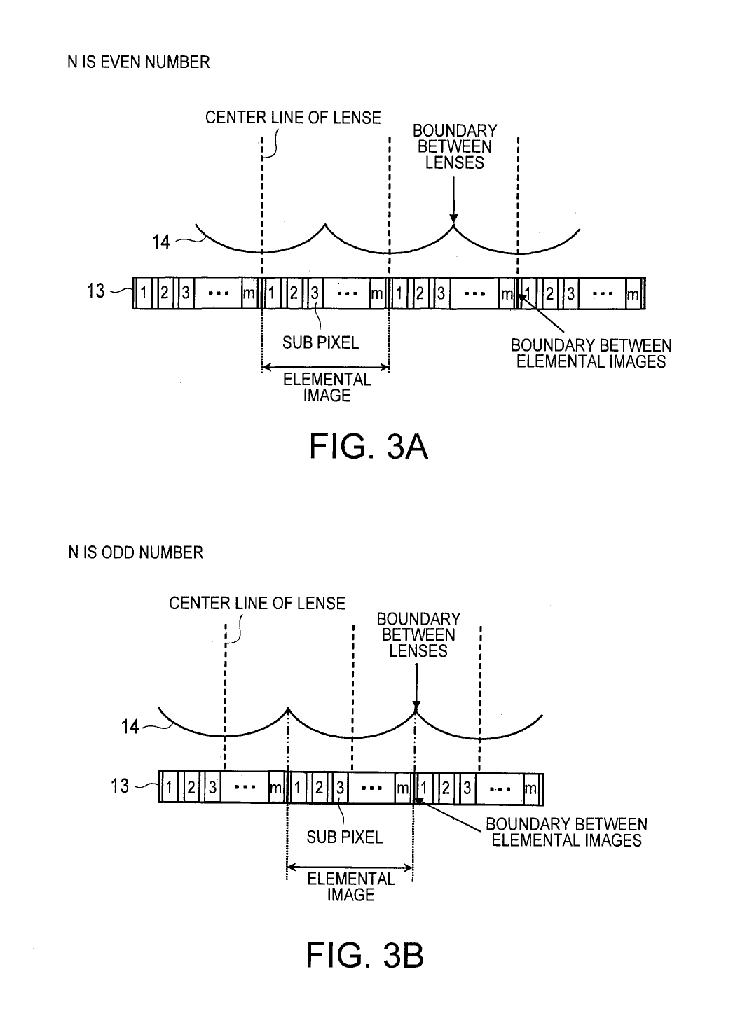

The luminous flux control element 112 controls an advance direction of luminous fluxes to go the luminous fluxes of N fields along respective direction (N directions). The display unit 13 and the image control element 14 in FIG. 2 are explained by referring to FIG. 3˜5.

FIGS. 3A and 3B show a positional relationship between the display unit 13 and the image control element 14. As to the display unit 13, in the case of “N=even number” and the case of “N=odd number”, a position of an elemental image corresponding to one lens of the image control element 14 is different. This reason is to make a viewing region be symmetric at the right and left side. FIG. 3A shows the case of “N=even number” and FIG. 3B shows the case of “N=odd number”.

The elemental image includes sub pixels (of m units) corresponding to a parallax number m. Briefly, the elemental image is a unit composing a parallax image having m parallaxes for one field. In FIGS. 3A and 3B, a number assigned to each sub pixel represents the parallax number corresponding to a parallax number. By sub pixels having the same parallax number, one elemental image is displayed.

In the case of “N=even number” (FIG. 3A), a boundary between elemental images positions at a center line of one lens of the image control element 14. In the case of “N=odd number” (FIG. 3B), a boundary between elemental images positions at an extension line of a boundary between two lenses of the image control element 14.

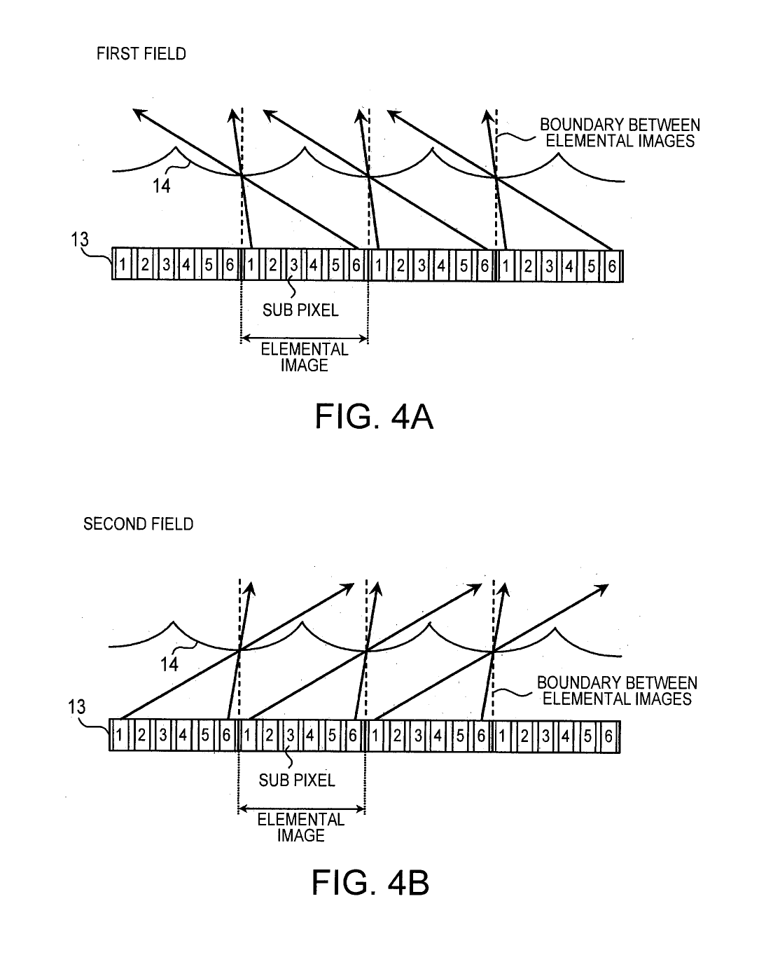

FIGS. 4A and 4B show an emission direction of a luminous flux in the display unit 13 and the image control element 14 in the case of “N (time division number)=2 and m (parallax number of one field)=6”. Especially, FIGS. 4A and 4B show the emission direction of the luminous flux emitted from sub pixels having parallax numbers 1 and 6. FIG. 4A shows an example of the emission direction of the luminous flux of the first field. FIG. 4B shows an example of the emission direction of the luminous flux of the second field.

By the emitter 111 and the luminous flux control element 112, a luminous flux corresponding to each field passes through the display unit 13 with a different angle. For example, in the case of the first field (FIG. 4A), a luminous flux passes through a sub pixel having a parallax number 1, and advances toward the left upper direction. However, in the case of the second field (FIG. 4B), a luminous flux passes through the sub pixel having the parallax number 1, and advances toward the right upper direction. Briefly, in the case of “the time division number=N (N fields in one frame)”, each luminous flux passes through the display unit 13, and advances along N directions. In this example, luminous fluxes pass through the display unit 13, and advance along two directions.

Furthermore, each luminous flux passing through sub pixels having different parallax numbers (for each field) differently advances along m directions by the image control element 14. As a result, parallax numbers having m directions are assigned to the parallax image of one field.

Briefly, in the first embodiment, the parallax number m can be assigned to one field. Accordingly, as to one frame (N fields), a stereoscopic image having the parallax number (N×m) can be displayed. In FIGS. 4A and 4B, the stereoscopic image having the parallax number 12 (N×m=2×6) can be displayed.

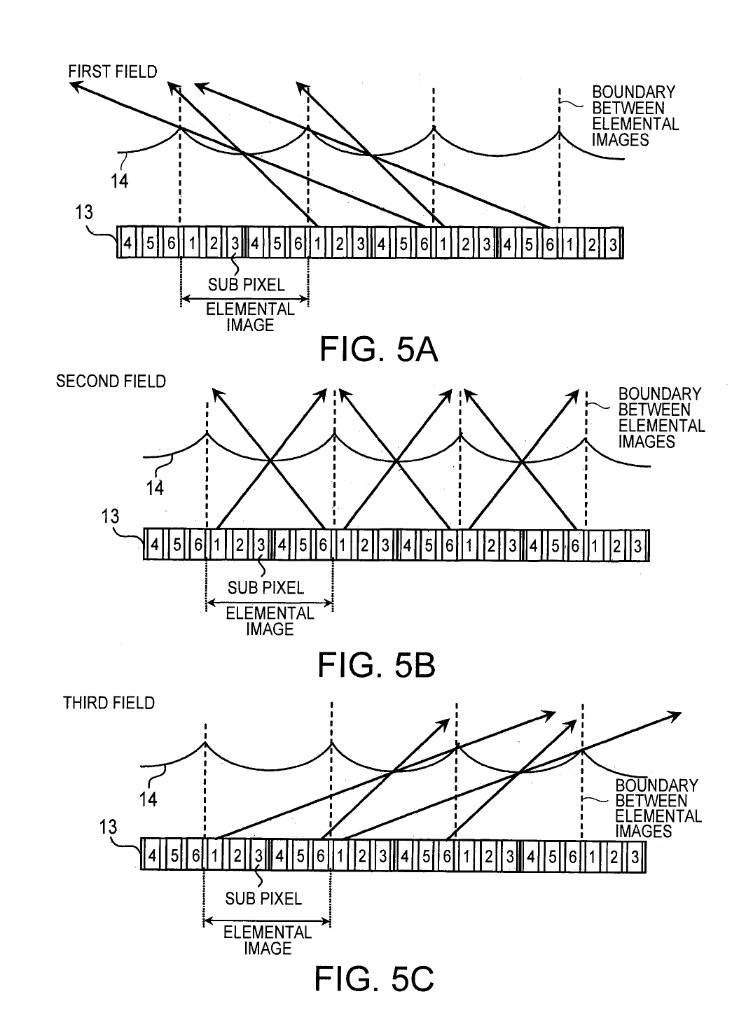

FIGS. 5A, 5B and 5C show an emission direction of a luminous flux in the display unit 13 and the image control element 14 in the case of “N (time division number)=3 and m (parallax number of one field)=6”. In FIGS. 5A, 5B and 5C, in the same way as FIGS. 4A and 4B, the stereoscopic image having the parallax number 18 (N×m=3×6) can be displayed.

As mentioned-above, according to the first embodiment, the parallax number can be increased.

In the first embodiment, by devising a location of light sources S of the emitter 111, occurrence of crosstalk between fields can be suppressed.

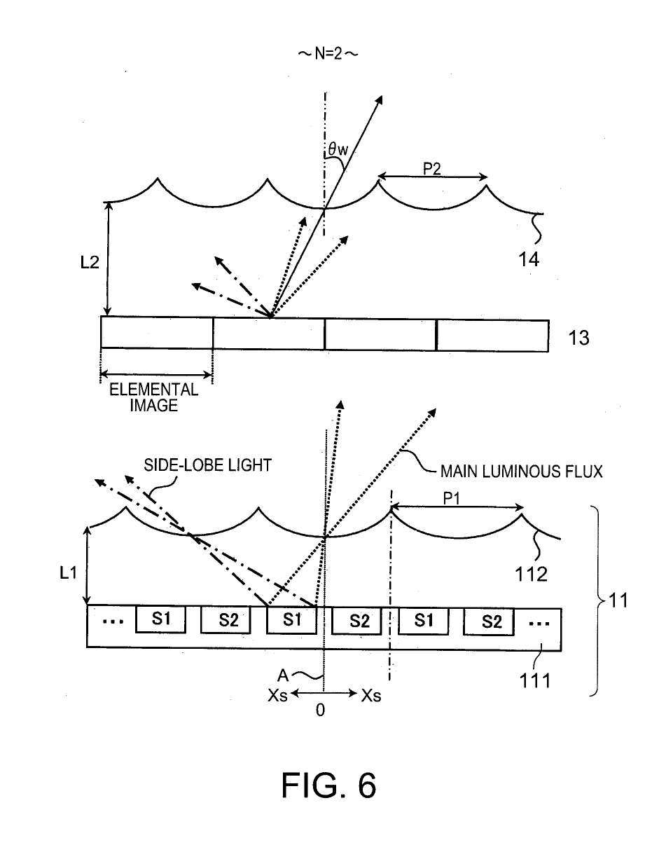

FIG. 6 is a schematic diagram to explain a location of light sources S in the emitter 111. FIG. 6 shows the case of “N (time division number)=2”. In FIG. 6, a half value of a viewing region of the parallax image of one field (determined by a positional relationship between the display unit 13 and the image control element 14) is θw. A distance along a surface of the emitter 111 from a center line A of one lens of the luminous flux control element 112 is Xs.

In general, the luminous flux emitted from the light source S includes an expanse. Accordingly, when a luminous flux emitted from the light source S of an illumination unit is incident to another illumination unit adjacent to the illumination unit, a side-lobe light occurs. When the side-lobe light passes through the image control element 14, a crosstalk between fields occurs.

In order to remove the crosstalk, in the first embodiment, the light source S is located so that the side-lobe light is emitted from the luminous flux control element 112 with at least predetermined angle from the normal direction of the luminous flux control element 112.

For example, in one illumination unit, assume that a pitch width (width of lens) of the luminous flux control element 112 is P1, a distance from the emitter 111 to the luminous flux control element 112 is L1, and a half value of the viewing region is θw. By using these parameters, each light source S of the emitter 111 is located so as to be within a range of Xs satisfying an equation (1). As a result, occurrence of the side-lobe light is suppressed.

$${tan}^{- 1} ( \frac{{X}_{s}}{{L}_{1}} ) \geq ( N - 1 ) \times {θ}_{w} \\ {tan}^{- 1} ( \frac{{P}_{1} - {X}_{s}}{{L}_{1}} ) \geq ( N + 1 ) \times {θ}_{w} \qquad ( 1 )$$

Briefly, in the first embodiment, each light source S is located so that an emission angle of the side-lobe light from the normal direction of the luminous flux control element 112 is larger than or equal to N (the number of fields) times of the half value θw of the viewing region.

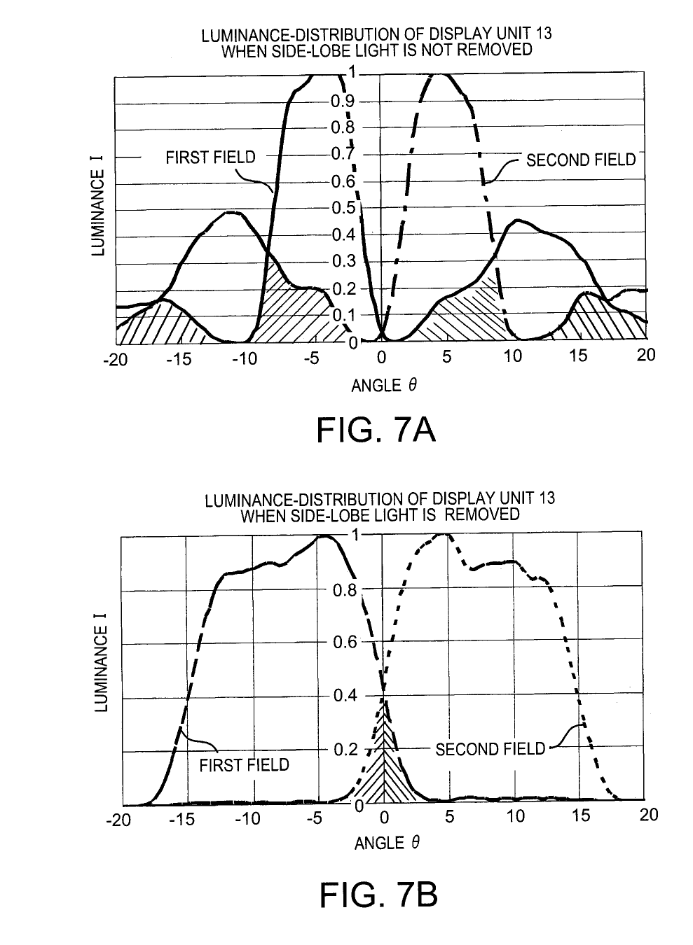

FIGS. 7A and 7B show luminance-distribution of the display unit 13 in the case of not removing the side-lobe light and the case of removing the side-lobe light. FIG. 7A shows the case of not removing the side-lobe light, and FIG. 7A shows the case of removing the side-lobe light. In FIG. 7A, an area (oblique line part) where a luminance-distribution of the first field overlaps a luminance-distribution of the second field exists.

Briefly, this area means that a main luminous flux of the first field includes a side-lobe light of the second field (a main luminous flux of the second field includes a side-lobe light of the first field). As a result, the observer perceives this area as a crosstalk between fields.

On the other hand, in the first embodiment, as mentioned-above, occurrence of the side-lobe light is suppressed. As shown in FIG. 7B, in comparison with FIG. 7A, the area (oblique line part) is narrower. Briefly, this means that occurrence of crosstalk between fields is suppressed.

In this way, according to the first embodiment, occurrence of crosstalk can be suppressed.

Next, in the first embodiment, by using the correction table 50, occurrence of luminance irregularity is suppressed.

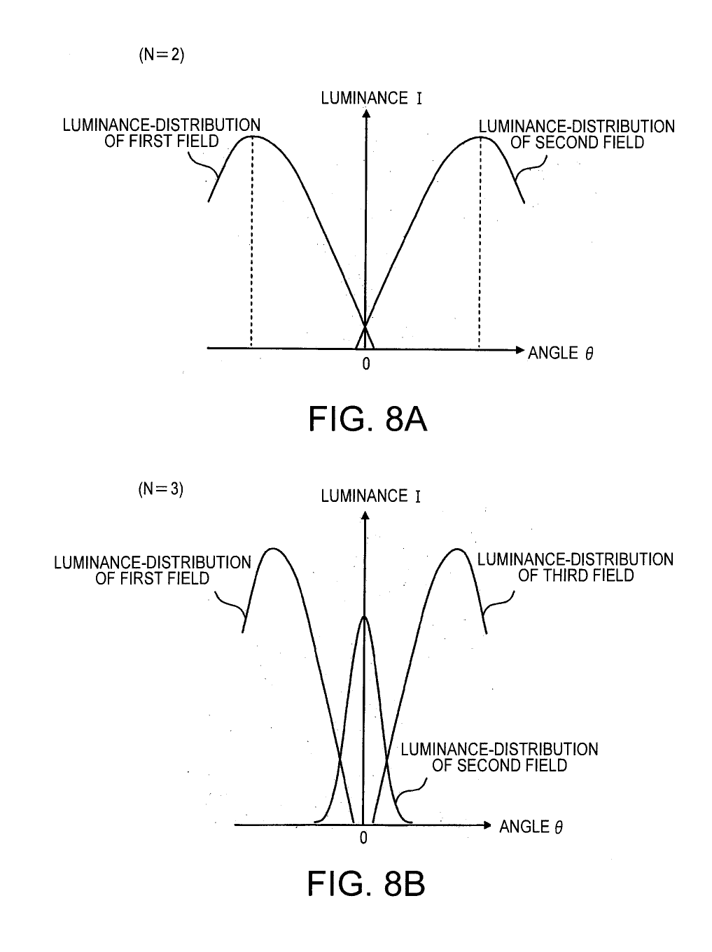

FIG. 8A and 8B show a luminance-distribution which luminance of luminous fluxes (passed through the image control element 14) is summed for all parallaxes (N×m) in the case of not using the correction table 50. FIG. 8A shows a luminance-distribution in the case of “N (time division number)=2”. FIG. 8B shows a luminance-distribution in the case of “N (time division number)=3”. In FIGS. 8A and 8B, a horizontal axis represents an angle θ of the emission direction from the normal direction (θ=0) of the emitter 111, and a vertical axis represents a luminance I(θ).

As shown in FIG. 8A, each luminance-distribution of the first field and the second field has a peak as a direction of a predetermined angle from the normal direction (θ=0) of an emission surface of the emitter 111. When an angle of the emission direction shifts from the peak, the luminance I more reduces. Furthermore, two peaks of the luminance I of the first field and the second field have symmetric angles at the normal direction (θ=0).

As shown in FIG. 8B, each luminance-distribution of the first field and the third field has a peak as a direction of a predetermined angle from the normal direction (θ=0) of an emission surface of the emitter 111. When an angle of the emission direction shifts from the peak, the luminance I more reduces. Furthermore, two peaks of the luminance I of the first field and the third field have symmetric angles at the normal direction (θ=0). A luminance-distribution of the second field has a peak at the normal direction (θ=0). When the angle θ shifts from the normal direction (θ=0), the luminance I more reduces.

Briefly, as shown in FIGS. 8A and 8B, in both cases that N (time division number) is even number or odd number, the luminance I changes by the angle θ shifted from the normal direction of the emitter 111. This is a cause to occur the luminance irregularity.

In order to remove the luminance irregularity, in the first embodiment, the correction table 50 previously stores correction information to fix the luminance I irrespective of the angle θ. By using the correction table 50, the correction unit 152 corrects image data supplied from the input unit 151.

For example, the correction table 50 stores a correction equation (2) as the correction information. By using the correction equation (2) the correction unit 152 corrects the image data.

$$Ic = I ( θ ) \times \frac{I ( {θ}_{peak} )}{I ( {θ}_{max} )} \qquad ( 2 )$$

In the equation (2) I(θ) represents a luminance of each pixel before correction. I(θₚₑₐₖ) represents a peak luminance of profile of each viewpoint. I(θₘₐₓ) represents a maximum luminance I(θ) in a range “−θₜ<θ<θₜ”. “θₜ” represents a half value of a design viewing angle. The design viewing angle is a viewing angle when all fields are displayed. Briefly, “θₜ” is N (the number of fields) times of the half value (θ_{w}) of the viewing angle of the parallax image of one field. I_{c} represents a luminance of each pixel after correction.

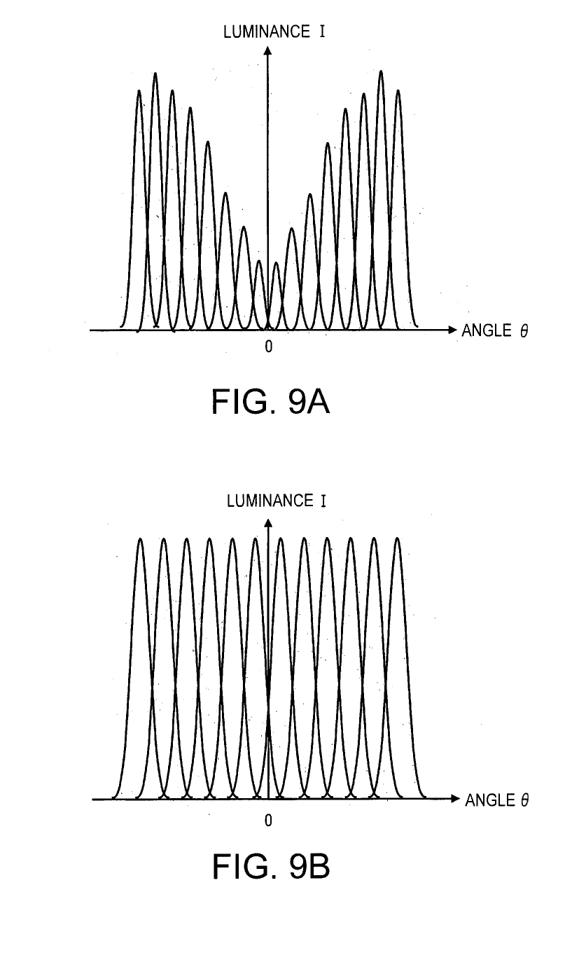

FIGS. 9A and 9B show a luminance-distribution before correction (FIG. 9A) and after correction (FIG. 9B) in the case of “N (time division number)=2”. As shown in FIG. 9B in comparison with FIG. 9A, by correcting the image data by the correction unit 152 using the correction table 50, the luminance-distribution is changed as a fixed value.

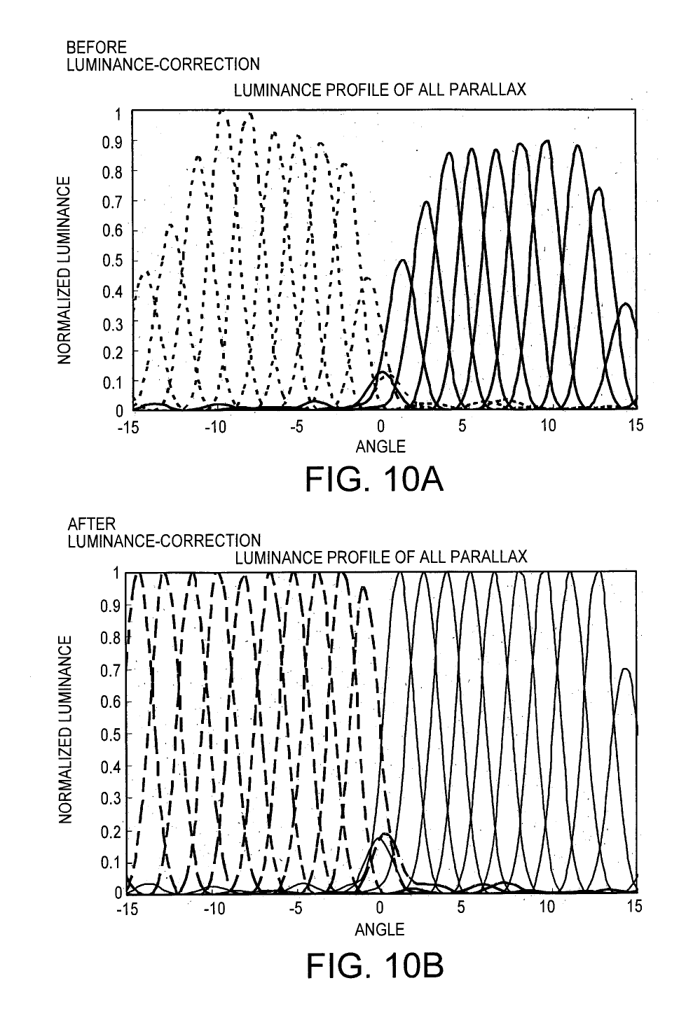

FIGS. 10A and 10B show a luminance-distribution of the parallax image (displayed by the display unit 13) before correction (FIG. 10A) and after correction (FIG. 10B). As shown in FIG. 10B, in comparison with FIG. 10A, by correcting the image data by the correction unit 152 using the correction table 50, the luminance of each parallax is essentially equal in a range of the viewing angle. Briefly, in the first embodiment, the luminance irregularity can be suppressed.

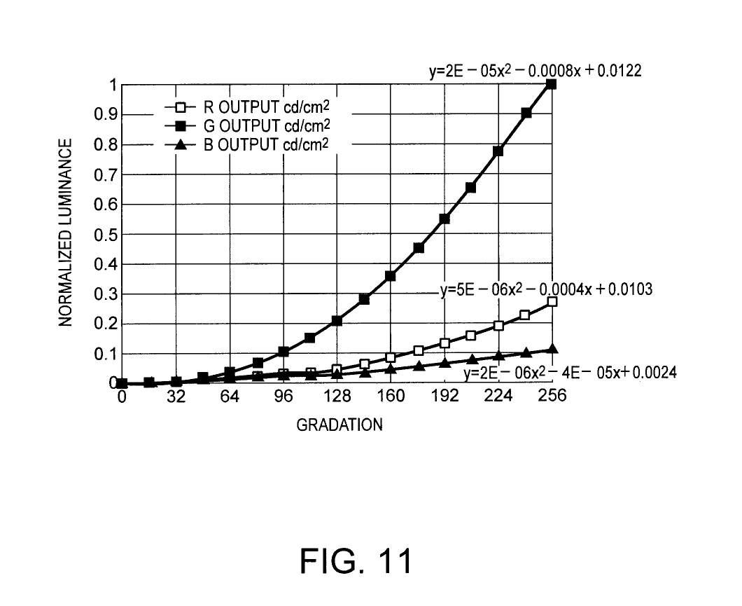

Moreover, in the first embodiment, the display unit 13 may control the luminance-distribution. FIG. 11 is a graph showing a correspondence between a luminance of the image data and a gradation of the display unit 13, in order for the display unit 13 to control the luminance-distribution. As shown in FIG. 11, by previously measuring a relationship (matched with characteristics of the display unit 13) between the luminance and the gradation for each color (RGB) element, the luminance may be converted to the gradation.

As mentioned-above, according to the first embodiment, while occurrences of the crosstalk and the luminance irregularity are suppressed, the parallax image having the larger number of parallaxes can be displayed.

### The Second Embodiment

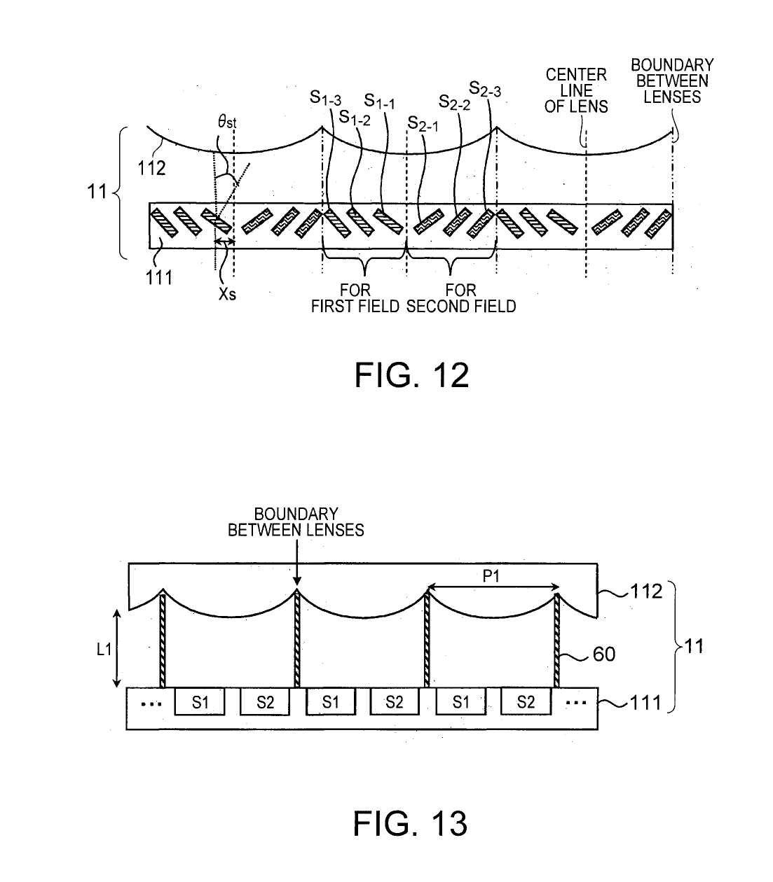

In the second embodiment, a location of the light source S of the emitter 111 is different from that of the first embodiment. FIG. 12 shows a positional relationship between the normal direction of the emitter 111 and the luminous flux control element 112 according to the second embodiment.

In the emitter 111, a plurality of light sources S (K units) for one field is equipped. The normal direction of each light source S is different. In FIG. 12, the illumination unit 11 includes three light sources S₁₋₁, S₁₋₂ and S₁₋₃ for the first field, and three light sources S₂₋₁, S₂₋₂ and S₂₋₃ for the second field.

In order to reduce the luminance irregularity, the plurality of light sources S (K units) for one field had better close each other. Furthermore, one light source located at the end of the plurality of light sources had better extend to a boundary between lenses of the luminous flux control element 112. However, if a width P₁ of the lens of the luminous flux control element 112 satisfies an equation (3), the crosstalk between fields are apt to occur by the side-lobe light.

P₁<2×tan{(N+1)×θ_{w}} (3)

Accordingly, in the second embodiment, in order to reduce the crosstalk between fields, a position Xₛ of the light source S (from a center line of the lens of the luminous flux control element 112) and an angle θₛₜ of the light source to be inclined are related to satisfy an equation (4).

$${θ}_{st} = \frac{{θ}_{t}}{2} - {tan}^{- 1} ( \frac{{P}_{1} - 2 {X}_{s}}{2 \times {L}_{1}} ) \qquad ( 4 )$$

In the equation (4), θₜ represents an emission angle based on characteristics of intensity distribution of the light source S.

According to the second embodiment, by adjusting an inclination of the light source S of the emission 111, occurrence of the crosstalk between fields can be suppressed.

### The Third Embodiment

In the third embodiment, a shielder 60 to shield the side-lobe light is located between the emitter 111 and the luminous flux control element 112. This is different from the first and second embodiments. FIG. 13 shows a positional relationship between the emitter 111 and the luminous flux control element 112 according to the third embodiment.

As shown in FIG. 13, the shielder 60 is located between the emitter 111 and the luminous flux control element 112. Concretely, the shielder 60 is located at an extension line of the boundary between two lenses of the luminous flux control element 112. By equipping the shielder 60, the side-lobe light is shielded. As a result, occurrence of the cross talk between fields can be suppressed.

### The Fourth Embodiment

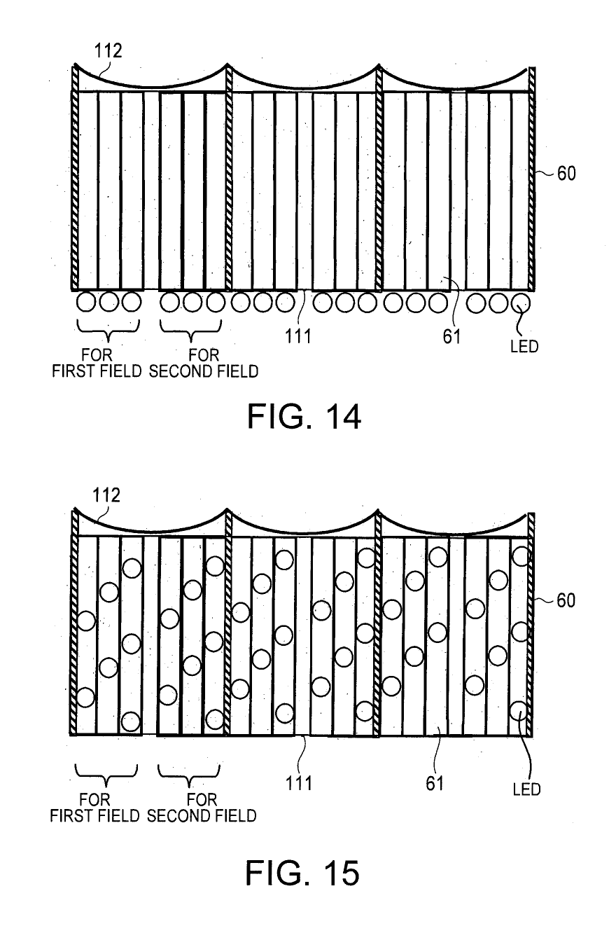

In the fourth embodiment, a light source S of the emitter 111 is a LED array. FIG. 14 shows the emitter 111 according to the fourth embodiment. The emitter 111 has an array structure composed by a plurality of light guide panels 61 and a LED located at the end of each light guide panel. The LED generates a luminous flux from the end of the light guide panel.

### Modification

In the emitter 111, the LED may not be located at the end of the light guide panel. FIG. 15 shows the emitter 111 according to the modification of the fourth embodiment. As shown in FIG. 15, a plurality of LEDs is arranged at an arbitrary interval along a direction perpendicular to the luminous flux control element 112.

In this case, LEDs for one field are located so as not to arrange on a straight line along a direction horizontal to the luminous flux control element 112. By this location, the luminance irregularity occurred from individual difference of each LED can be suppressed.

According to the fourth embodiment and the modification thereof, the LED can be used as the emitter 111.

As mentioned-above, according to the first, second, third and fourth embodiments, the stereoscopic image display apparatus able to display the parallax image having the larger number of parallax can be provided.

While certain embodiments have been described, these embodiments have been presented by way of examples only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An apparatus for displaying a stereoscopic image, comprising:
an illuminator including a plurality of illumination units, each illumination unit being configured to emit a plurality of luminous fluxes, each luminous flux being emitted along one direction differently;
a display unit oppositely located to the illuminator, on which a plurality of sub pixels is arranged, each sub pixel being configured to display a parallax image corresponding to the luminous flux in one direction; and
an image control element oppositely located to the illuminator via the display unit, on which a plurality of apertures is arranged, each aperture being configured to control a direction of the parallax image.

2. The apparatus according to claim 1, wherein
the illumination unit includes
a plurality of light sources configured to emit respectively, and
an optical element oppositely located to the plurality of light sources, configured to emit each luminous flux from the plurality of light sources along one of a plurality of directions differently,
a light source is located, when a luminous flux emitted from the light source is incident to another optical element not oppositely located to the light source, so that the luminous flux is incident to the another optical element with at least a predetermined angle from the normal direction of the optical element.

3. The apparatus according to claim 2, wherein
the predetermined angle is larger than or equal to N times of a half value θ_{w} of a viewing angle determined by a positional relationship between the display unit and the image control element (N: the number of fields of the parallax image).

4. The apparatus according to claim 3, wherein,
if a position along a horizontal direction from the normal line of the optical element is Xₛ, a width of the optical element along the horizontal direction is P₁, and a distance between the light source and the optical element is L₁,
the plurality of light sources in the illumination unit is located within a range of the position Xₛ satisfying an equation (1).
$${tan}^{- 1} ( \frac{{X}_{s}}{{L}_{1}} ) \geq ( N - 1 ) \times {θ}_{w} \\ {tan}^{- 1} ( \frac{{P}_{1} - {X}_{s}}{{L}_{1}} ) \geq ( N + 1 ) \times {θ}_{w} \qquad ( 1 )$$

5. The apparatus according to claim 1, further comprising:
a correction unit configured to correct a luminance of each pixel of the parallax image so that the luminance along each parallax direction is substantially fixed in a viewing region determined by a positional relationship between the display unit and the image control element.

6. The apparatus according to claim 5, wherein
the parallax image includes a plurality of elemental images arranged, each elemental image including sub pixels of parallax numbers 1˜m corresponding to each parallax direction,
if N (the number of fields of the parallax image) is an even number,
the display unit displays the parallax image so that a boundary between two elemental images is located at a center of the aperture, and
the correction unit,
at a field smaller than N/2, more decreases the luminance of the sub pixel corresponding to the aperture when the parallax number is larger, and
at a field larger than or equal to N/2, more increases the luminance of the sub pixel corresponding to the aperture when the parallax number is larger.

7. The apparatus according to claim 5, wherein
the parallax image includes a plurality of elemental images arranged, each elemental image including sub pixels of parallax numbers 1˜m corresponding to each parallax direction,
if N (the number of fields of the parallax image) is an odd number,
the display unit displays the parallax image so that a boundary between two elemental images is located at a boundary between two apertures, and
the correction unit,
at a field smaller than or equal to (a quotient of N/2), more decreases the luminance of the sub pixel corresponding to the aperture when the parallax number is larger,
at a field equal to ((a quotient of N/2)+1), increases or decreases the luminance of the sub pixel corresponding to the aperture so that the luminance of the sub pixel of a parallax number (a quotient of m/2) is a peak, and
at a field larger than or equal to ((a quotient of N/2)+2), more increases the luminance of the sub pixel corresponding to the aperture when the parallax number is larger.

8. The apparatus according to claim 2, wherein
the light source is further divided into a plurality of light sources each oppositely arranged to the aperture, and
each light source divided is located with a different angle from the normal direction of the illuminator.

9. The apparatus according to claim 2, wherein
the illuminator includes a plurality of shielders,
each shielder is located along a direction from a position between two illumination units to a position between two optical elements oppositely located to the two illumination units, so as to shield the luminous flux between the two illumination units.
